(19) United States
(12) Patent Application Publication
(10) Pub. No.: US 2005/0149083 A1
(43) Pub. Date: Jul. 7, 2005

(54) Terminal guide for rotational atherectomy device and method of using same

(76) Inventors: Dmitriy Prudnikov, New Hope, MN (US); Svenn Edvin Borgersen, Eagan, MN (US)

Correspondence Address: ALTERA LAW GROUP, LLC, 6500 CITY WEST PARKWAY, SUITE 100, MINNEAPOLIS, MN, 55344-7704, US

(21) Appl. No.: 10/753,040

(22) Filed: Jan. 7, 2004

(51) Int. Cl. A61D 1/02

(52) U.S. Cl. 606/159

(57) ABSTRACT

A terminal guide for a helically wound drive shaft for use in an rotational atherectomy device. The terminal guide is atraumatic to prevent perforation of the arterial wall or the embedding of the device into the arterial wall. The terminal guide may be pre-machined, cast, molded or formed in any manner that maintains the required dimensions and tolerances and may be fabricated from any biocompatible material and coated with radiopaque material to more accurately position the rotational atherectomy device without going past the distal end of the pre-positioned guide wire.

### BACKGROUND OF THE INVENTION

### FIELD OF THE INVENTION

The present invention relates to medical devices, more particularly, devices and methods for removing tissue from a body lumen, such as removal of atherosclerotic plaque from arteries, utilizing a rotational atherectomy device.

### SUMMARY OF THE INVENTION

A terminal guide for a helically wound drive shaft for use in a rotational atherectomy device. The terminal guide is atraumatic to prevent perforation of the arterial wall or the embedding of the device into the arterial wall. The terminal guide may be pre-machined, cast, molded or formed in any manner that maintains the required dimensions and tolerances. The terminal guide may be fabricated from any biocompatible material and coated or formed with radiopaque material to more accurately position the rotational atherectomy device without going past the distal end of the pre-positioned guide wire.

An object and advantage of the present invention is to provide an atraumatic terminal guide for the drive shaft of a rotating atherectomy device.

Another object and advantage of the present invention is to provide an atraumatic terminal guide for a rotating atherectomy device that minimizes or eliminates the possibility that the device's drive shaft is advanced past the distal end of the pre-positioned guide wire.

Another object and advantage of the present invention is to provide an atraumatic terminal guide for a rotating atherectomy device that minimizes or eliminates the unwanted eccentric motion of the drive shaft distal end.

Yet another object and advantage of the present invention is to provide an atraumatic terminal guide for a rotating atherectomy device that reduces surface erosion of the guide wire as a consequence of unwanted eccentric motion of the drive shaft and frictional welding of the drive shaft to the guide wire, while increasing the useful life of both the drive shaft and the guide wire.

The foregoing objects and advantages of the invention will become apparent to those skilled in the art when the following detailed description of the invention is read in conjunction with the accompanying drawings and claims. Throughout the drawings, like numerals refer to similar or identical parts.

### DISCUSSION OF THE RELATED ART

A variety of techniques and instruments have been developed for use in the removal or repair of tissue in arteries and similar body passageways. A frequent objective of such techniques and instruments is the removal of atherosclerotic plaques in a patient's arteries. Atherosclerosis is characterized by the buildup of fatty deposits in a patient's blood vessels. Often, over time, what initially is deposited as relatively soft, cholesterol-rich atheromatous material hardens into a calcified atherosclerotic plaque. Such atheromas restrict the flow of blood, and therefore often are referred to as stenotic lesions or stenoses, with the blocking material referred to as stenotic material.

Orbital atherectomy procedures have become common for removing such stenotic material. Such procedures are used most frequently to initiate the opening of calcified lesions in coronary arteries.

Several kinds of rotational atherectomy devices have been developed for removal of stenotic materials. In one type of device, such as that disclosed in U.S. Pat. No. 4,990,134 (Auth), a nickel-plated burr covered with an abrasive cutting material such as diamond particles is carried at the distal end of a flexible drive shaft. The burr rotates at high speeds (typically in the range of about 80,000-200,000 rpm) while it is advanced across the stenosis. As the burr is removing stenotic material, however, it also blocks blood flow. Further, once the burr has advanced across the stenosis, the artery will have been opened to a diameter equal to or only slightly larger than the maximum outer diameter of the burr. Moreover, fluoroscopy is typically utilized to assist the physician in placing the nickel-plated Auth-type burr in the general location of a stenosis in an artery. However, since the nickel-plated burr is not radiopaque, the ability of the physician to monitor, in real time, the actual removal of stenotic tissue is significantly hampered. In addition, this has an adverse effect on the ability of the physician to manage the risk of perforating the arterial wall while ensuring that the stenotic tissue is completely removed.

Moreover, the Auth-type burr uses a multi-step, electrochemical deposition process to plate the nickel on the distal tip of the burr. A secondary process requires hand work to remove any sharp edges and to drill a center shaft through the deposited nickel, leaving the distal tip with a profile resembling that of a drill bit with a hole through the center. The difficulties with the known process are that it is costly, time-consuming and it is extremely difficult to control. The results of the uncontrolled hand fluting of the distal tip is that it creates potential for misalignment of the central bore through the burr with the guide wire. This creates undesirable eccentric motion of the distal end which, in turn, may create surface erosion of the guide wire as the drive shaft rubs against it, friction welding of the drive shaft to the guide wire and, ultimately premature failure of the drive shaft and/or the guide wire may ensue. Finally, because the distal ends of the Auth-type burr have a fluted profile, during the procedure the rotating flutes are capable of either embedding into or perforating the arterial wall of the drive shaft is deployed beyond the end of the guide wire.

U.S. Pat. No. 5,314,438 (Shturman) discloses another atherectomy device having a drive shaft with a section of the drive shaft having an enlarged diameter, at least a segment of this enlarged diameter being covered with an abrasive material to define an abrasive segment of the drive shaft. When rotated at high speeds, the abrasive segment is capable of removing stenotic tissue from an artery. While this atherectomy device possesses several advantages over the Auth device due to its flexibility, it also is capable of only opening an artery to a diameter about equal to the diameter of the enlarged diameter section of the drive shaft. In addition, though this device permits use of intravascular ultrasound imaging to monitor the removal of stenotic tissue, thus reducing the risk of perforation of the tissue removing surface during the procedure, the device may remain susceptible to the problem of perforation due to the advancement of the device beyond the end of the guide wire which may result in perforation.

U.S. Pat. No. 6,494,890 (Shturman) discloses an atherectomy device having a drive shaft with a section of the drive shaft having an eccentric enlarged diameter, at least a segment of this enlarged eccentric diameter being covered with an abrasive material. When rotated at high speeds and placed within an artery against stenotic tissue, the eccentric nature of the enlarged diameter section cause the section to rotate in such a fashion as to open the stenotic lesion to a diameter substantially larger than the outer diameter of the enlarged diameter section. This device does permit use of intravascular ultrasound imagine to monitor the removal of stenotic tissue, thus reducing the risk of perforation of the tissue removing surface during the procedure. However, the device may remain susceptible to the problem of perforation due to the difficulties in monitoring the advancement of the device beyond the end of the guide wire which may result in perforation.

### BRIEF DESCRIPTION OF THE DRAWINGS

FIG. 1 is a perspective view of a rotational atherectomy device of the invention.

FIG. 2 is a perspective, broken-away view of an enlarged diameter section of the drive shaft of a rotational atherectomy device of the invention.

FIG. 3A is a broken away, longitudinal cross-sectional view of the eccentric embodiment of the enlarged diameter section of the drive shaft of the invention.

FIG. 3B is similar to FIG. 3A, with the addition of an external tissue removing member.

FIG. 4A is a broken away, longitudinal cross-sectional view of the concentric embodiment of the enlarged diameter section of the atherectomy device of the invention.

FIG. 4B is a detail of FIG. 4A in the circled area, showing the terminal guide of the present invention.

FIG. 5 is a broken away, longitudinal cross-sectional view of the terminal guide.

FIG. 6 is a broken away, longitudinal cross-sectional view of the terminal guide with radiused or chamfered edges.

FIGS. 7A and 7B are broken away, longitudinal cross-sectional views of the terminal guide with radiused or chamfered edges and a radioopaque jacket.

### DETAILED DESCRIPTION OF THE INVENTION

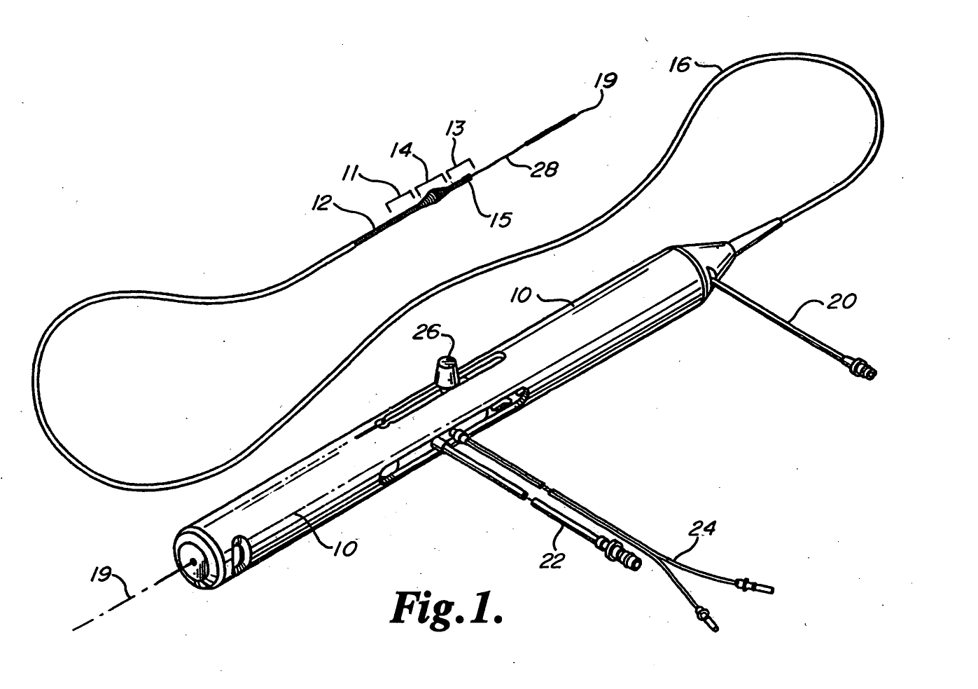

With reference to the Figures, the present inventive design incorporates a radiopaque atraumatic terminal guide at the distal end of the drive shaft. Specifically, with reference to FIG. 1, a typical rotational atherectomy device is illustrated. The device includes a handle portion 10, an elongated, flexible drive shaft 12, having an enlarged diameter section 14, and an elongated catheter 16 extending distally from the handle portion 10. The drive shaft 12 and its enlarged diameter section 14 are constructed from helically coiled wire. The catheter 16 has a lumen in which most of the length of the drive shaft 12 is disposed, except for the enlarged diameter section 14 and a short section distal 13 to the enlarged diameter section 14. The drive shaft 12 also contains an inner lumen 30, permitting the drive shaft 12 to be advanced, retracted and rotated over a guide wire 28. A fluid supply line 20 may be provided for introducing cooling and lubricating fluid, typically saline or other biocompatible solution, into the catheter 16.

The handle 10 generally contains a turbine (or similar rotational drive mechanism) for rotating the drive shaft 12 at high speeds. The handle and turbine typically may be connected to a power source, such as compressed air delivered through a tube 22. A pair of fiber optic cables 24 may also be provided for monitoring the speed of rotation of the turbine and drive shaft 12. The handle also desirably includes a control knob 26 for advancing and retracting the turbine and drive shaft 12 with respect to the catheter 16 and the body of the handle 10.

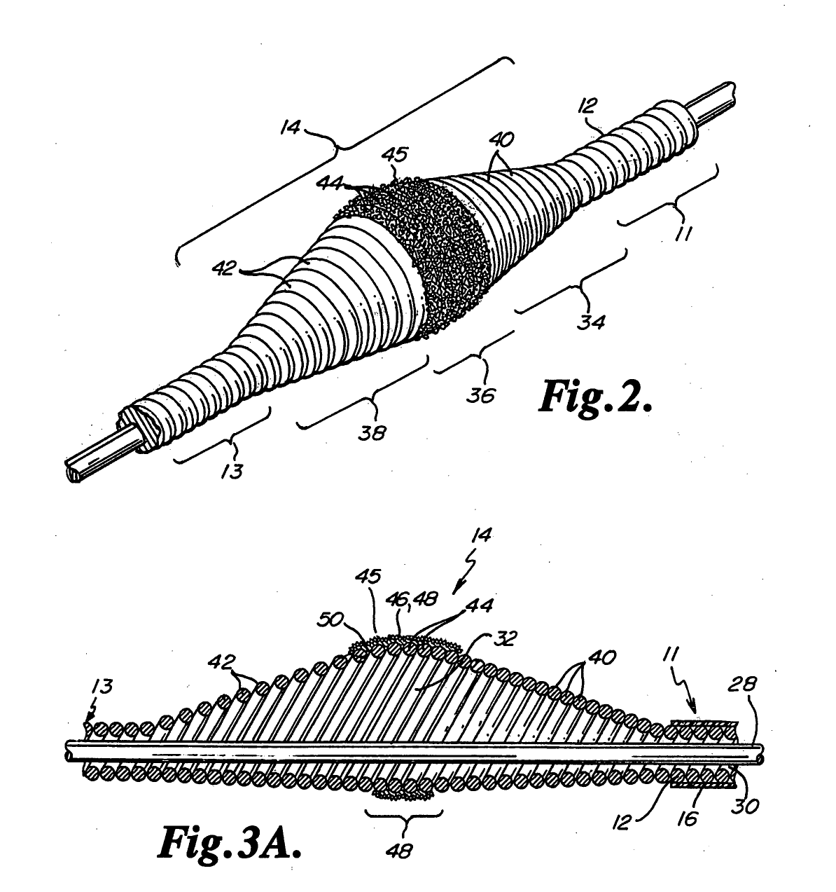

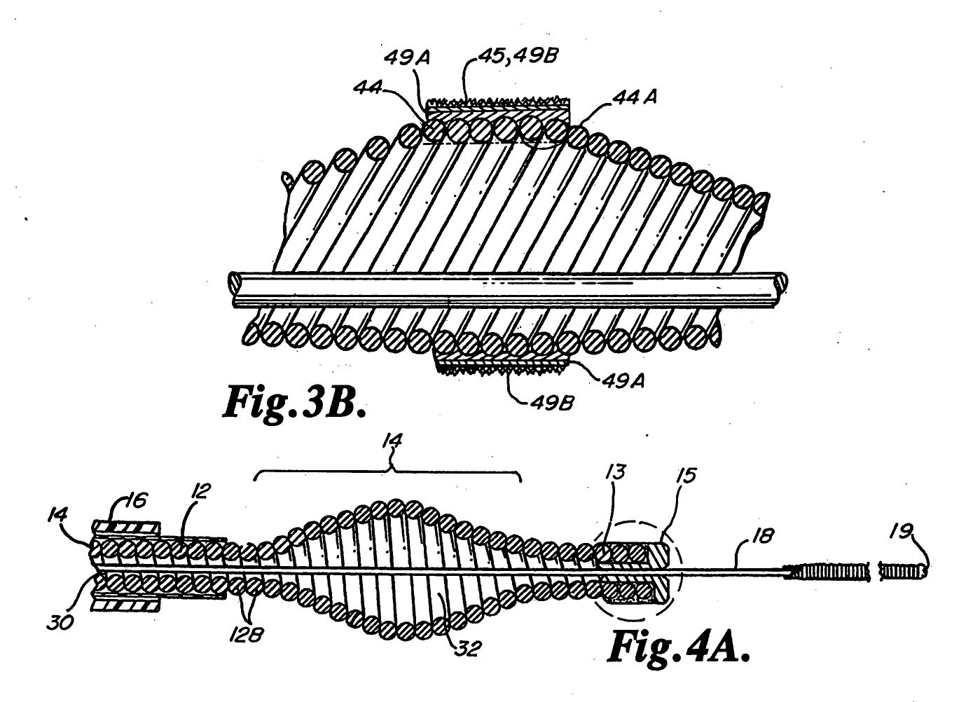

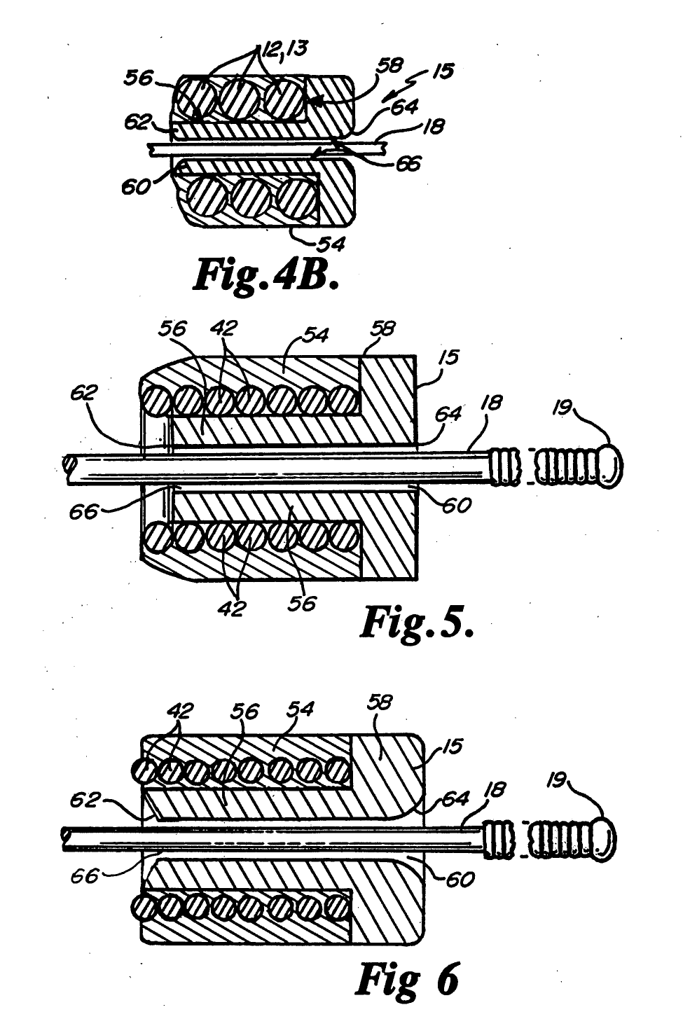

The enlarged diameter section 14 may be concentric or eccentric in profile. FIGS. 2 and 4 illustrate details of the concentric embodiment of the enlarged diameter section 14 while FIG. 3 illustrates an alternate eccentric embodiment. It should be understood that, as used herein, the term “eccentric” is intended to refer to either a difference in location between the geometric center of the enlarged diameter section 14 and the rotational axis of the drive shaft 12, and/or to a difference in location between the center of mass of the enlarged diameter section 14 and the rotational axis of the drive shaft 12. Either difference, at the proper rotational speeds, will enable the eccentric embodiment of the enlarge diameter section 14 to open a stenosis to a diameter substantially greater than the nominal diameter of the eccentric embodiment of the enlarged diameter section 14.

Continuing with reference to FIGS. 1-4, the drive shaft 12 is comprised of one or more helically wound wires 128 defining a guide wire lumen 30 and a hollow cavity 32 within the enlarged diameter section 14. The hollow cavity is substantially empty, except for the guide wire 28 traversing the hollow cavity 32. The enlarged diameter section 14 includes proximal 34, intermediate 36 and distal 38 portions in both the concentric and eccentric embodiments. Wire turns 40 of the proximal portion 34 preferably have diameters that progressively increase distally at a generally constant rate, thereby forming generally the shape of a cone. Wire turns 42 of the distal portion 38 preferably have diameters that progressively decrease distally at a generally constant rate, thereby forming generally the shape of a cone. Wire turns 44 of the intermediate portion 36 are provided with gradually changing diameters to provide a generally convex outer surface shaped to provide a smooth transition between the proximal and distal conical portions of the enlarged diameter section 14 of the drive shaft 12. The elongated drive shaft 12 is illustrated with a distal section 13 and a proximal section 11, located respectively distally and proximally of the enlarged diameter section 14.

Turning to FIGS. 2 and 3A, at least part of the enlarged diameter section 14 includes an external surface capable of removing tissue. In the preferred embodiment, the tissue removal surface is disposed on the intermediate portion 36 of the enlarged diameter section 14. Preferably the tissue removing surface 45 comprises a coating of an abrasive material 46 to define a tissue removing segment 48 of the drive shaft 12. The abrasive material may be any suitable material, e.g., diamond powder, fused silica, titanium nitride, tungsten carbide, aluminum oxide, boron carbide, or other ceramic materials. Preferably, the abrasive material is comprised of diamond chips, or diamond dust particles, attached directly to the wire turns of the drive shaft 12 by a suitable binder 50. Such attachment may be achieved using well known techniques such as conventional electroplating or fusion technologies. (See, e.g., U.S. Pat. No. 4,028,576). Alternatively, the external tissue removing surface 45 may simply be a section of the wire turns that has been roughened to provide a suitably abrasive surface. In another embodiment, the external surface may be etched or cut, perhaps with a laser, to provide small but sharp cutting surfaces. One skilled in the art will recognize that other equivalent techniques may be utilized to provide a suitable tissue removal surface.

FIG. 3B illustrates another embodiment, in which an external abrading member or crown 49A is attached to the wire turns 44 by some suitable method such as brazing. The external abrading member 49A may, for example but only illustratively, be a stainless steel hoop. An abrading surface 49B, such as diamond chips, diamond powder, fused silica, titanium nitride, tungsten carbide, aluminum oxide, boron carbide, or other ceramic material, is coated onto the external abrading member 49A. Preferably, the wire turns 44 in this embodiment are caused during manufacturing to follow a flat plane 44A.

With reference to the Figures, the inventive drive shaft terminal guide will now be described. The terminal guide 15 (FIGS. 4A and 4B) is attached to the distal end 13 of the helically wound drive shaft 12. The terminal guide 15 is attached using bonding material 54 or any other method known in the art. The terminal guide 15 has a reduced outer diameter proximal surface 56 and an enlarged outer diameter distal surface 58 to facilitate attachment to the helically wound drive shaft. Those skilled in the art will readily recognize equivalent alternative profiles that will allow and facilitate attachment of the terminal guide to the drive shaft. The distal end 13 of the helically wound drive shaft 12 is adjacent and attached to the proximal surface 56 and abuts and is attached to the distal surface 58. The terminal guide 15 may thus be inserted inside the distal end 13 of the helically wound drive shaft 12 and secured in place by bonding matter 54 or other methods well known in the art.

The terminal guide 15 has a central orifice 60 therethrough sufficient in diameter to allow the guide wire 18 to pass through. The central orifice 60 has a proximal edge 62 and a distal edge 64. Referring now to FIG. 6, the terminal guide is illustrated having the proximal edge 62 radiused or chamfered to facilitate advancement and retraction of the drive shaft, and the terminal guide 15, over the guide wire 18. Similarly, the distal edge 64 is radiused or chamfered to facilitate advancement and retraction of the drive shaft 12, and the terminal guide 15, over the guide wire 18. In addition, radiusing or chamfering the distal edge 64 of the terminal guide 15 reduces any trauma that the otherwise sharp edges may cause to the arterial wall.

An interface 66 is formed between the guide wire 18 and the central orifice 60 of the terminal guide when the drive shaft 12 is deployed over the pre-positioned guide wire 18. In addition to the precision manufacturing of the terminal guide 15, further reduction of the possibility that the drive shaft 12, or the central orifice 60, will erode the guide wire 18 or become frictionally welded to the drive shaft 12 or central orifice 60 is obtained by introduction of a lubricating, cooling fluid flow within the interface 66. The fluid, typically saline or other biocompatible solution, may be introduced through a fluid supply line 20, as seen in FIG. 1.

The terminal guide 15 greatly reduces loading on the guide wire 18 from the drive shaft 12. As the drive shaft 12 rotates, a force is developed substantially normal to the axis of the guide wire 18. The present invention distributes the load from this force into the terminal guide 15 instead of onto the drive shaft 12. In conjunction with the lubricated bearing effect of lubricating, cooling fluid flowing within the interface 66, this substantially eliminates any gouging of the guide wire.

The terminal guide 15 may further be manufactured using radiopaque material either embedded throughout the terminal guide 15 or bands of radiopaque material may be interspersed along the terminal guide 15 to facilitate locating the terminal guide during the atherectomy procedure and to reduce or eliminate the possibility that the distal end 13 of the drive shaft 12 is advanced beyond the distal end 19 of the guide wire 18. Alternatively, the terminal guide may be coated with a radiopaque material. The radiopaque material thus reduces the possibility that healthy arterial tissue will be damaged or that the arterial wall will be perforated.

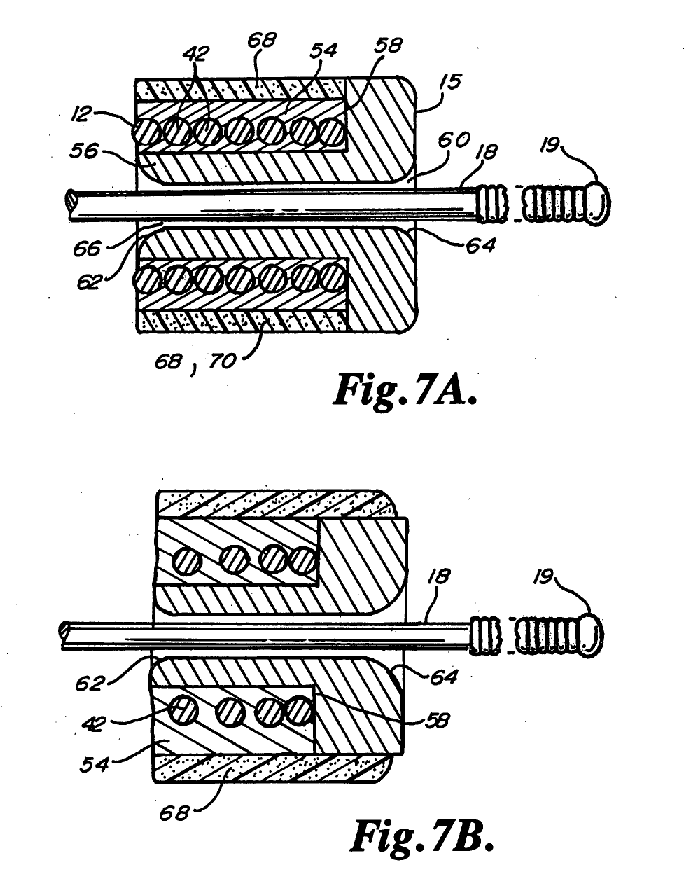

FIG. 7A illustrates an alternate embodiment. Here, a radiopaque jacket 68 is bonded to circumferentially surround the helically wound drive shaft 12 in the area of the reduced outer diameter of the proximal surface of the terminal guide 56. The radiopaque jacket 68 is attached to the enlarged outer diameter of the distal surface 58 of the terminal guide 15 by any known method such as bonding. In this embodiment, the outer diameter of the radiopaque jacket 68 is substantially equivalent to the outer diameter of the distal surface of the terminal guide 58 to provide a substantially smooth terminal guide outer diameter 70. To increase visibility of the terminal guide 15 during the atherectomy procedure, the jacket 68 may have radiopaque material embedded throughout the terminal guide or bands of radiopaque material may be interspersed substantially throughout the jacket 68. Alternatively, the jacket 68 may simply be coated with radiopaque material.

FIG. 7B shows another embodiment. Here, rather than having the jacket 68 attached to the enlarged outer diameter of the distal surface 58 of the terminal guide, the jacket 68 is applied to the terminal guide as a coating or tube, so that it extends outside the outer diameter of the distal surface 58 of the terminal guide 15.

The terminal guide 15 requires relatively high precision dimensional tolerances to prevent misalignment of the distal end 13 of the drive shaft 12 with respect to the pre-positioned guide wire 18. The impact of such misalignment is typically an unwanted eccentric motion which, in turn, may produce frictional surface erosion of the guide wire 18, frictional welding of the drive shaft 12 to the guide wire 18, and ultimately may produce premature failure of the drive shaft 12 and/or the guide wire 18. The required precision to prevent such misalignment in the present invention is preferably obtained by machining, casting, molding or otherwise precision forming by methods well known in the art so that the terminal guide precisely fits the distal end 13 of the drive shaft 12.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

1-25. (canceled)

26. A terminal guide for a rotational atherectomy device having an elongate, flexible, rotatable drive shaft, wherein the drive shaft comprises at least one helically wound wire and having a distal end and a proximal end, the at least one helically wound wire defining a lumen configured to receive a guide wire, the drive shaft further defining an enlarged diameter section, the terminal guide comprising:
a reduced outer diameter proximal surface and an enlarged outer diameter distal surface, wherein the proximal surface is inserted within the lumen of the distal end of the helically wound wire of the drive shaft and wherein the distal end of the helically wound wire of the drive shaft abuts the distal surface of the terminal guide, wherein at least a portion of the terminal guide extends beyond the distal end of the helically wound wire of the drive shaft and wherein the terminal guide reduces loading on the guide wire during high speed rotation by distributing the force, that is substantially normal to the guide wire, into the terminal guide instead of the drive shaft;
a central orifice through the terminal guide, to allow slidable advancement and retraction of the drive shaft over the guide wire and high-speed rotation of drive shaft and terminal guide about the guide wire;
the central orifice further having a proximal edge and a distal edge, wherein the distal edge is chamfered or radiused to facilitate advancement of the drive shaft over the guide wire and to prevent puncture damage to the artery during drive shaft advancement and rotation;
the terminal guide further having a distal edge that is chamfered or radiused to minimize trauma to the arterial wall as the drive shaft is advanced over the guide wire, wherein the terminal guide is manufactured in such a way so that it is radiopaque.

27. The terminal guide of claim 26, further comprising a radiopaque material that is disposed on the terminal guide to facilitate ensuring that the drive shaft is not advanced beyond guide wire.

28. The terminal guide of claim 26, wherein the radiopaque material further comprises radiopaque bands interspersed along the terminal guide.

29. The terminal guide of claim 26, further comprising the terminal guide having a radiopaque coating.

30. The terminal guide of claim 26, further comprising a radiopaque jacket circumferentially bonded to the terminal guide, wherein the jacket may be attached to cover at least a portion of the terminal guide and wherein the jacket presents a smooth profile to prevent damage to arterial tissue during advancement, retraction of the drive shaft over the guide wire as well as during high-speed rotation of the drive shaft.

31. The terminal guide of claim 26, further comprising the proximal edge being chamfered or radiused to facilitate advancement and retraction of the drive shaft over the guide wire.

32. The terminal guide of claim 26, further comprising the central orifice of the terminal guide having tolerances sufficiently precise to allow high-speed rotation of the drive shaft and terminal guide about the guide wire without unwanted eccentric motion.

33. A method of removing stenotic tissue from a stenotic lesion in an artery, comprising:
providing a flexible and elongated guide wire;
providing a flexible, elongated and rotatable drive shaft having an enlarged diameter section, at least part of the enlarged diameter section having a tissue removing surface, the drive shaft comprising at least one helically wound wire the wire having a proximal end and a distal end, wherein an atraumatic terminal guide comprising a radiopaque material is attached to the distal end of the wire so that at least a portion of the terminal guide extends beyond the distal end of the helically wound wire;
using the radiopaque terminal guide to ensure that the drive shaft is not advanced beyond the guide wire as the procedure occurs, advancing the rotatable drive shaft over the pre-positioned guide wire within the artery to a location adjacent the stenotic tissue, and rotating the drive shaft while moving the enlarged diameter section across the stenotic lesion, thereby opening the stenotic lesion to a diameter essentially equal to that of the enlarged diameter section; and
reducing loading on the guide wire during high speed rotation by distributing the force, that is substantially normal to the guide wire, from the drive shaft to the terminal guide.

34. The method of claim 31, further comprising providing a chamfered or radiused distal edge on the terminal guide to minimize trauma as the drive shaft is advanced and rotated within the artery.

35. The method of claim 34, further comprising providing a central orifice within the terminal guide, the central orifice having a proximal edge and a distal edge, the proximal surface being chamfered or radiused to facilitate advancement and retraction of the drive shaft over the guide wire; and wherein the distal edge is chamfered or radiused to facilitate advancement of the drive shaft over the guide wire and to prevent puncture damage to the artery during drive shaft advancement and rotation.
